(19) United States
(12) Patent Application Publication
(10) Pub. No.: US 2008/0222898 A1
(43) Pub. Date: Sep. 18, 2008

(54) Device for Cutting Sheet Material

(76) Inventor: Peter John Staples, Queensland (AU)

Correspondence Address: WARD AND SMITH, P.A., 1001 COLLEGE COURT, P.O. BOX 867, NEW BERN, NC, 28563-0867, US

(21) Appl. No.: 12/089,572

(22) PCT Filed: Oct. 13, 2006
(86) PCT No.: PCT/AU06/01503

§ 371 Date: Apr. 8, 2008

(30) Foreign Application Priority Data
Oct. 13, 2005 (AU) 2005905653
Nov. 4, 2005 (AU) 2005906120

(51) Int. Cl. B26B 15/00

(52) U.S. Cl. 30/277.4

(57) ABSTRACT

A device for cutting sheet material, especially sheet metal having a contoured structure such as ridges or corrugations, the device including (a) a support (21) adapted to attach the device to a power source (11) (manual, electric or hydraulic); (b) a first blade portion (15) with a first blade (19); (c) a second blade portion (16) with a second blade (20); (d) a first coupling portion (17, 13) which operatively couples the first blade portion (15) to the power source (11) and adapted to allow pivoting of the first blade portion (15) when the power source (11) is activated; and (e) a second coupling portion (18, 14) which either (i) operatively couples the second blade portion (16) to the power source (11) and is adapted to allow pivoting of the second blade portion (16) when the power source (11) is activated or (ii) is adapted to prevent the second blade portion (16) from pivoting when the power source (11) is activated, as required; wherein the pivoting of the first blade portion (15) and/or the second blade portion (16) provides a cutting action by the first blade (19) and the second blade (20). When only a single blade is to pivot, it is the lower blade which pivots upwards to meet the fixed second blade. The coupling portions (15, 16) can be adapted to enable a required grade of cut to be pre-determined from the cutting action of the device.

### FIELD OF THE INVENTION

THIS INVENTION relates to cutting tools. In particular, it is directed to one or more tools or devices suitable for cutting sheet material, such as metal.

### BACKGROUND OF THE INVENTION

There are many different types of cutting tools, for example, aviation snips, tin snips, hack saws, angle grinders, Beverly throatless shears, electric power shears, electric jigsaws, nibblers etc. In general, each of these different cutting tools are suitable for different applications.

In the roofing industry, roofing caps must be configured so that their side walls abut with the tiling or metal roofing on either side. For corrugated metal roofing or corrugated tiles, the side walls of the caps must be cut so that they have a matching configuration to the adjacent roof. The process of cutting a series of curved edges or corrugations in each side wall is not an easy process using current cutting tools. Aviation snips are the most adept tools at cutting or scribing along a continuous curved path, but the cutting process is long and tedious. Furthermore, cutting continuous wavelike curves over a period of time is physically demanding.

Although there have been prior attempts to use powered cutting tools to cut the curved edges required, invariably, they are unable to cut a complete curve because they must be used in situ and, to date, no device has been made available which can be used to cut continuously along a curved path. At best, mechanized cutting tools are first used for part of the curve which is being cut and aviation snips or tin snips are then used to complete the curve.

Generally, these prior art attempts suffer from having blades with a large jaw opening over a long cutting length, the cutting length extending deep into the throat of the jaw opening, a characteristic which reduces the ability to negotiate arcuate paths as it inhibits lateral pivoting of the blades; they also tend to vibrate or bounce along the material being cut requiring a firm hand pressure to maintain control; and they generally inhibit maneuverability when cutting along a path substantially transverse to the contoured sheet metal.

It is a general object to overcome, or at least ameliorate, one or more of the above-mentioned disadvantages to provide a device suitable for cutting along linear or arcuate paths in sheet material, especially metal, the material having a contoured structure such as ridged or corrugated.

### SUMMARY OF THE INVENTION

According to a first aspect of the present invention, there is provided a device for cutting sheet material, said device including:
a support adapted to attach said device to a power source;
a first blade portion with a first blade;
a second blade portion with a second blade;
a first coupling portion which operatively couples said first blade portion to said power source and adapted to allow pivoting of said first blade portion when said power source is activated; and
a second coupling portion which either (i) operatively couples said second blade portion to said power source and is adapted to allow pivoting of said second blade portion when said power source is activated or (ii) is adapted to prevent said second blade portion from pivoting when said power source is activated, as required;
wherein said pivoting of said first blade portion and/or said second blade portion provides a cutting action by said first blade and said second blade.

Preferably, said sheet material is metal.

Preferably, said metal is of a ridged or corrugated profile.

Preferably, said cutting action includes scribing, shearing, cutting and the like.

Said power source may be by mechanical, electrical or hydraulic means.

When said power source is by electrical means, said power source may be in close association with said support or may be remote therefrom.

When said power source is in close association with said support, said support may be attached directly to an electric drill.

When said power source is an electric drill, said support may be adapted to either be attached directly to the shaft of said drill or to the chuck of said drill.

When said power source is remote from said support, said power source may be a portable battery pack.

When said power source is by mechanical means, said power source may be selected from a hand drill, auger or the like.

When said second blade portion is prevented from said pivoting, said first blade portion should be adapted to move substantially upwardly to enable said first blade to meet said second blade to provide said cutting action. Preferably, movement of said first blade should be to an upper position no higher than the fixed position of said second blade. The present inventor has established that such motion offers a significant improvement in said cutting action over known prior art as it enables cut waste material to be displaced to one side and upwardly away from the resultant cut edge.

Said support can be of any convenient construction adapted to be compatible with said power source to attach said device thereto and can comprise, but is not limited to, (a) a hollow tubular member configured to attach to a drill casing; or (b) a plate-like support with an associated shaft for attachment to the chuck of a drill; or (c) mechanical linkages attached to arms for a manually operated said device in a scissor-like motion.

When said support is a said tubular member or plate-like, said support may include at least one aperture for said first and second coupling portions to pass through.

In one embodiment of the present invention, said device may include one or more of the following preferred features:
first and second shaft coupling members, each said coupling members being operatively connected to respective said first and second coupling portions and being attached to the end of the shaft of a drill;
each said first and second shaft coupling members may comprise a cylindrical member with an off centre axial passage therethrough;
each said first and second shaft coupling members may function as a toothless pinion;
each said first and second shaft coupling members may have a circular periphery;
each said first and second shaft coupling members may be a tubular member attachable to a rotatable shaft of a drill;
each said first and second shaft coupling members may be an annular disk which is configured to fit over the end of a rotatable shaft of a drill;
said first shaft coupling member may be attached to the end of said shaft of said drill and said second shaft coupling member may be attached behind said first shaft coupling member and out of alignment therewith;
said first and second shaft coupling members may be mounted to the end of the shaft so that they are substantially oppositely aligned;
the major radius of said first shaft coupling member may be 180° in an opposite direction to the major radius of said second shaft coupling member;
said first and second shaft coupling members are attached to the shaft of a drill such that, when said shaft rotates, said coupling members are 180° out of phase with each other.

In another embodiment of the present invention, said device may include one or more of the following preferred features:
one said shaft coupling member may comprise a cam surface;
both said shaft coupling members may comprise a cam surface;
at least one said shaft coupling member may comprise a gear wheel.

In a further embodiment of the present invention, said device may include one or more of the following preferred features:
said first coupling portion may comprise a first coupling member which contacts said first shaft coupling member;
said second coupling portion may comprise a second coupling member which contacts said second shaft coupling member;
said first coupling member may be attached to the proximal end of said first blade portion;
said second coupling member may be attached to the proximal end of said second blade portion;
said first and second coupling members may be either permanently fixed or removably attached to their respective ends of said first and second blade portions;
said first coupling portion may comprise first coupling members on substantially diametrically opposite sides of the first shaft coupling member;
said second coupling portion may comprise second coupling members on substantially diametrically opposite sides of the second shaft coupling member;
said first and second coupling portions may comprise rocker arms which contact diametrically opposite sides of respective said shaft coupling members;
said first and second coupling portions may each comprise a U-shaped member/portion;
said first coupling portion may extend laterally from said first blade portion;
said second coupling portion may extend laterally from said second blade portion;
both said first and second coupling portions may extend laterally from the same side of their respective blade portions;
said first and second coupling portions may each extend laterally at substantially right angles from said first and second blade portions respectively;
each blade may extend upwardly from the distal end of its respective blade portion;
said first and second blade portions may be connected at the distal end through a pivot member;
said pivot member may be connected to said support;
said pivot member may extend laterally through each said first and second blade portions;
said pivot member may extend through a shin portion of each said first and second blade;
each said first and second blade may extend laterally outwardly from the distal end of its respective blade portion;
said pivot member may extend laterally at an angle of approximately 45° between 70° and 30°;
said pivot member may extend upwardly at a small angle to vertical (0° to 20°);
each said first and second blade may tilt forwardly from a vertical axis;
said pivot member may extend laterally with respect to said first and second blade portions;
said first and second blade portions may extend substantially in parallel;
each said first and second blade portions may pivot up and down with respect to said pivot member when each said shaft coupling member rotates on said shaft;
said support may be attachable to a drill sing by said shaft coupling members.

### BRIEF DESCRIPTION OF THE DRAWINGS

Preferred embodiments of the present invention will now be described with reference to the accompanying drawings in which:

FIG. 1 depicts a side view of a hand held power drill incorporating a cutting device according to a first embodiment of the present invention;

FIG. 2 depicts a side view of cutting arm attachments of the device shown in FIG. 1;

FIG. 3 depicts a top view of the device shown in FIG. 1;

FIG. 4 depicts a front view of front and rear shaft coupling lobes of the device shown in FIG. 1 in a first mode of operation;

FIG. 5 depicts the shaft coupling lobes of FIG. 4 in a second mode of operation;

FIG. 6 depicts a front view of the shaft coupling lobes, rocker arms and casing of the device shown in FIG. 1;

FIG. 7 depicts a side view of the casing of the device shown in FIG. 1;

FIG. 8 depicts a device according to a second embodiment of the present invention;

FIG. 9 depicts a device according to a third embodiment of the present invention;

FIG. 10 depicts a device according to a fourth embodiment of the present invention;

FIG. 11 depicts a device according to a fifth embodiment of the present invention; and

FIG. 12 depicts a device according to a sixth embodiment of the present invention.

### DETAILED DESCRIPTION OF THE DRAWINGS

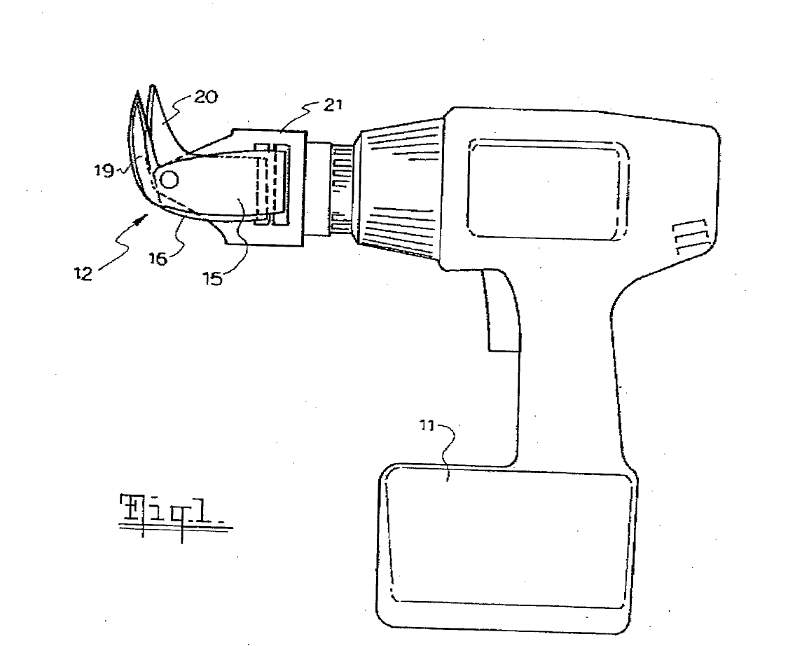

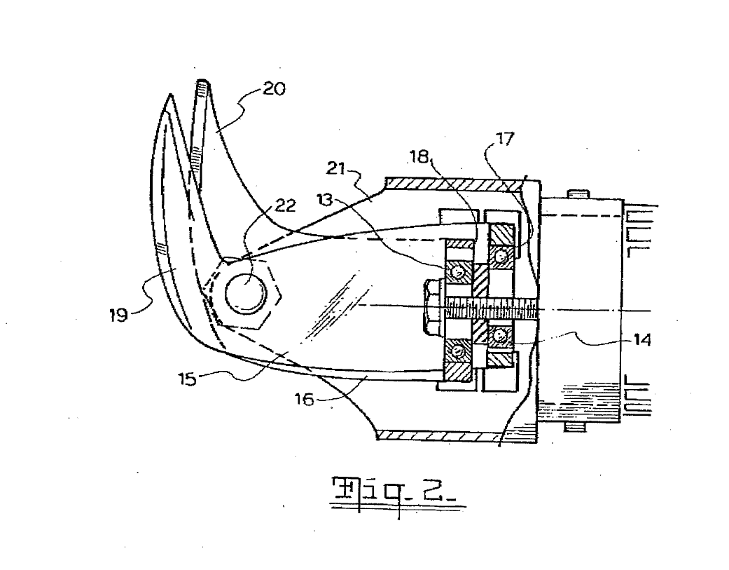

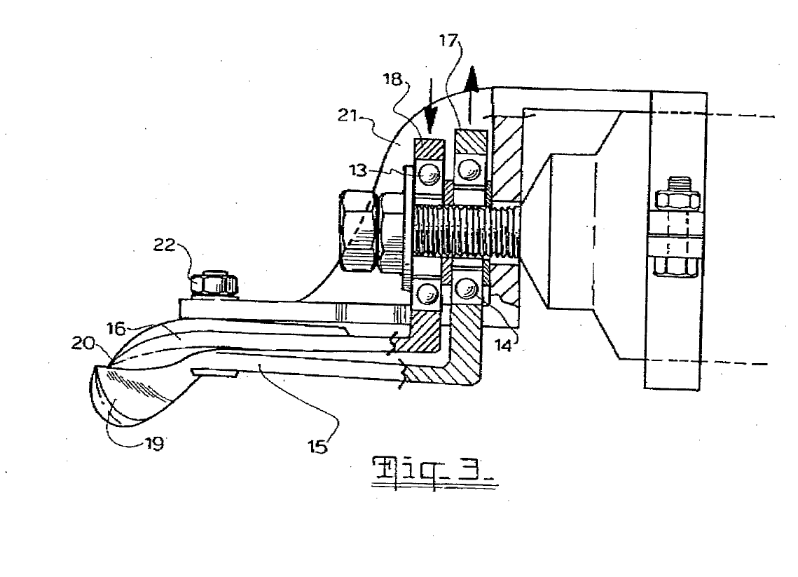

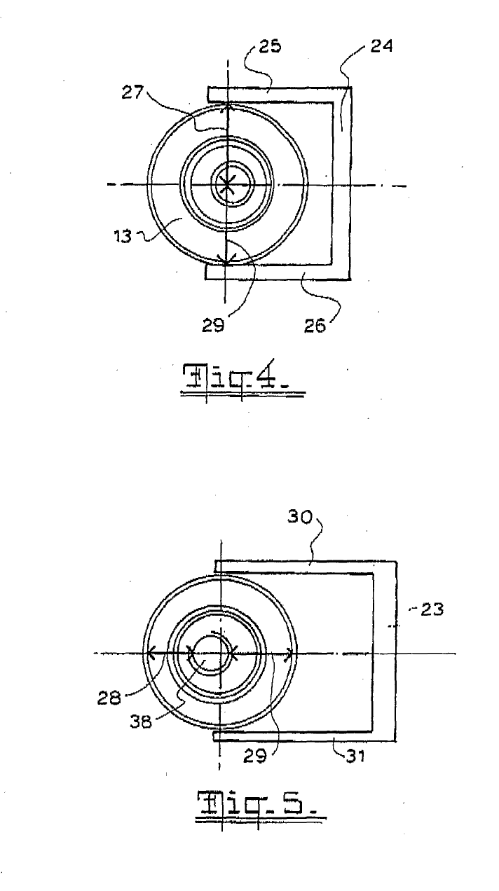

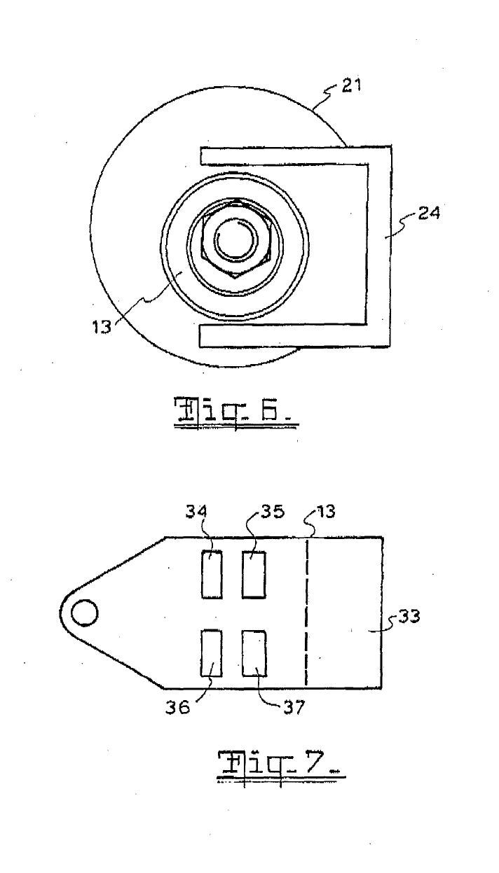

As shown in FIG. 1, a handheld power drill 11 is provided with a cutting device 12 in the form of an attachment. The cutting device 12 consists of shaft coupling lobes 13 and 14 which are placed over the end of the drill shaft of drill 11. Blade arms 15 and 16 shown more clearly in FIG. 2 have rocker arms 17, 18 at one end for coupling with the lobes 13 and 14. At the opposite end the blade arms 15 and 16 are provided with cutting blades 19, 20.

As shown in FIGS. 2 and 3, cuffing blade arms 15, 16 are fixed to a generally cylindrical housing or casing 21 which is attached to the end of the drill 11. The arms 15, 16 extend generally axially along the side of the casing 21 and are connected through a pivot pin 22 close to blades 19 and 20. The blades 19, 20 extend generally upwardly at a small angle to a vertical axis as shown in FIG. 1. The pivot 22 in the form of a screw passes through a distal end of the arms 15, 16 very close to the blades 19 and 20 in a similar fashion to the pivot in a pair of aviation snips. Likewise, the blades 19 and 20 are very similar to the blades of aviation snips and extend upwardly from the distal end of arms 15 and 16 at close to 90° thereto.

Each of the arms 15 and 16 preferably extend axially at a small angle with respect to each other and the pivot 22. The actual angle between the two arms will be dependent upon the position of the rocker arms. Furthermore, as the blades must move independently and relative to each other the shape and angle of the arms 15,16 may be varied depending upon the way in which the arms are coupled with the rotating shaft of the drill.

As shown in FIG. 3, the proximal ends of the arms 15 and 16 (the ends opposite to the blades 19, 20) extend at right angles in the form of generally U-shaped or C-shaped rocker arms 23, 24. Arm 16, which is the arm closest to the casing 21, has rocker arm 24 which has upper and lower arms 25, 26 as shown in FIG. 4. These arms 25, 26 extend tangentially to upper and lower peripheral edges of front coupling lobe 13. As shown in FIG. 4, the front coupling lobe 13 has a centrally offset axial hole 27 therethrough. In the position shown in FIG. 4, the minor radius of lobe 13 extends from the hole 27 vertically upwardly as referenced by item 28 and the major radius 29 extends vertically downwardly.

In contrast, in FIG. 4 the lobe 13 has rotated through 180° and the minor radius 28 is located at the bottom and the major radius 29 at the top. In contrast, the lobe 14 which is located behind lobe 13 although substantially identical in appearance to lobe 13, is fixed on the shaft of the drill 11 so that its major radius coincides with the minor radius of lobe 13 and its minor radius coincides with the major radius of lobe 13. As a result, lobes 13 and 14 are 180° out of phase.

FIG. 5 also shows rocker arm 23 and its upper and lower arms 30, 31.

Each of the lobes 13 and 14 are mounted on the shaft 32 of drill 11 and can be fixed permanently or by mounting screws or by any other suitable attachment method.

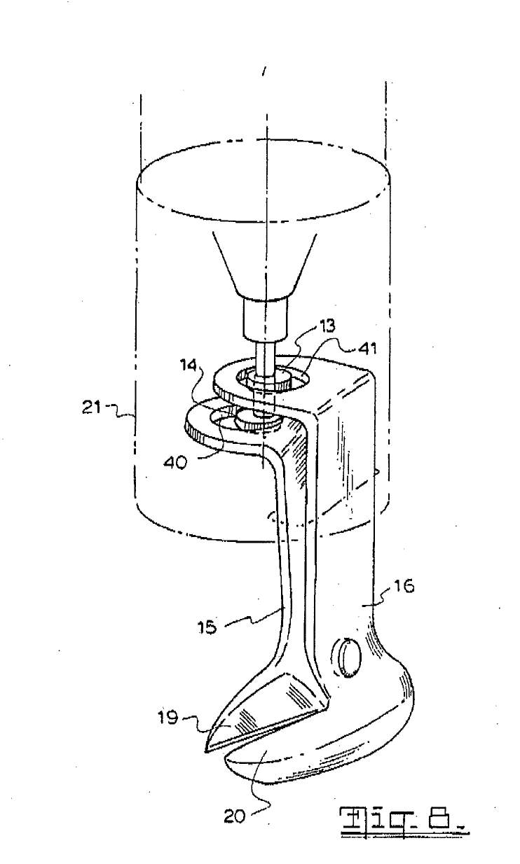

As shown in FIGS. 6 and 7, the casing to which the pivot is fixed is generally cylindrical and its side wall 33 adjacent arms 15 and 16 is provided with four symmetrical windows 34, 35, 36, 37 which permits entry of the rocker arms 25, 26, 30, 31. As shown in FIG. 6, windows 34 and 35 are rectangular and aligned one behind the other axially and windows 36 and 37 are symmetrically arranged below windows 34 and 35, again one behind the other. Thus windows 34 and 35 are horizontally aligned as are windows 36 and 37. Windows 34 and 36 are vertically aligned as are windows 35 and 37.

The casing 33 is preferably affixed to the end of the casing of the drill 11 by a screw thread attachment or other suitable attachment method.

To avoid or limit frictional contact between the inner walls of the arms 25, 26 and 30, 31, it is preferred that bearings be used between these arms and the respective lobes with which the arms are associated. For example, a race may be provided with bearings in it so that the bearings and race are able to move independently of the lobe and therefore reduce frictional contact with the aforementioned arms.

In operation, when the power drill 11 is operated the shaft rotates and the lobes 13 and 14 rotate, although their motion is eccentric because of the off centre location of the mounting holes 27 and 38. As each lobe turns the rocker arms with which it is associated reciprocates up and down with the eccentric orbital motion of the lobe. As lobes 13 and 14 are out of phase by 180°, one rocker arm moves up and down as the other moves down and up. As a consequence, arms 15 and 16 at their distal ends reciprocate up and down with the result that the blades 19 and 20 at the opposite ends move up and down in a cutting action as a result of the overlapping edges of the blades.

The degree of reciprocation of each arm 15, 16 and therefore the reciprocating distance of each of the blades 19 and 20 depends upon the degree of eccentricity of the holes through the lobes 13, 14. Therefore, if the lobes each had central holes there would be no rocking motion of the arms 15 and 16 (although it should be noted that using a gearing system this could be achieved without the C/U-shaped rocking arms). More practically, by varying the degree of eccentricity, the type of cut made by the device can be pre-determined—a lesser degree provides a fine cut, a higher degree a more coarse cut.

By increasing the distance of the hole from the centre of the lobe, each rocker arm reciprocates through a greater distance and the degree of relative movement between the arms 15 and 16 increases. Accordingly, the cutting action principle can be applied to different blade configurations. As an example, the blade configuration could be similar to that used in tin snips with the blades generally axially aligned with the arms.

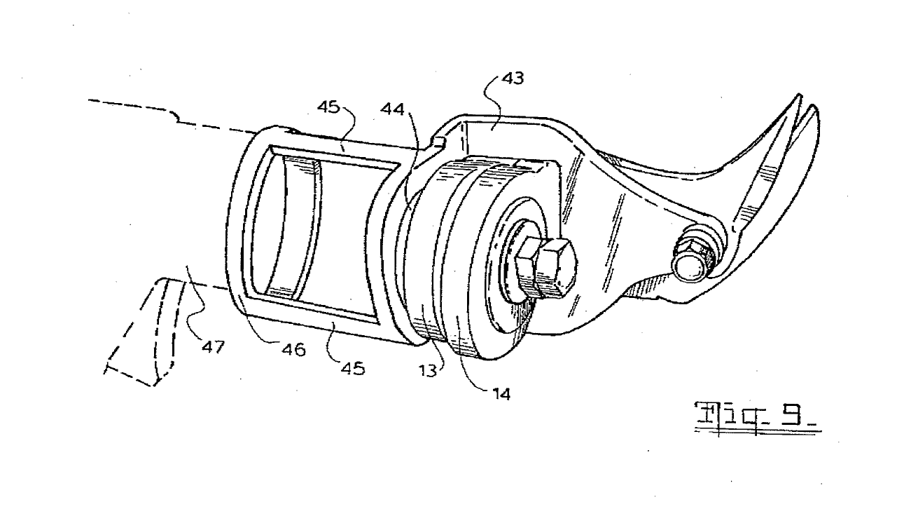

In the second embodiment shown in FIG. 8, the device operates very similar to that of the embodiment of FIG. 1, the differences being the blade arms 15 and 16 extend to respective rocker arms 38, 39 each containing an eccentric bore 40, 41 respectively to engage respective lobes 13, 14; and both rocker arms 38, 39 pass through a single slot 42 in the stepped housing 21.

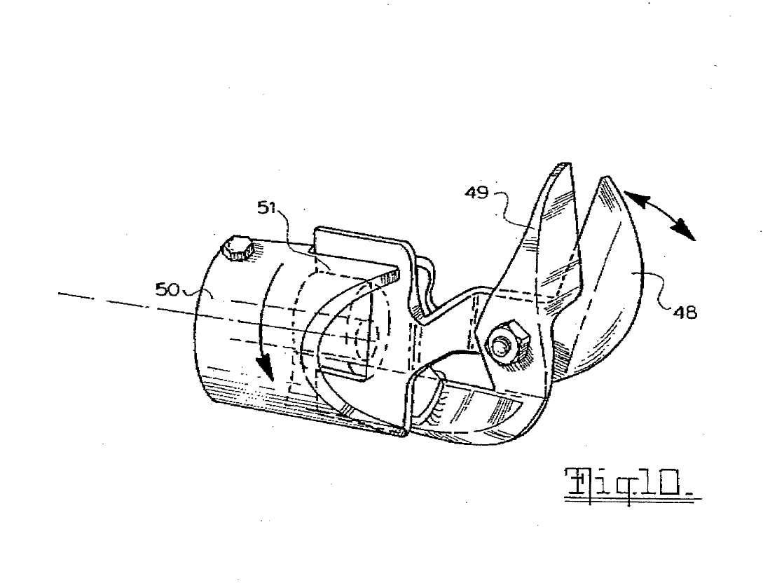

The third embodiment of the device shown in FIG. 9 functions very similarly to that described above with reference to the second embodiment, the differences being the support is essentially now a flat plate 43 with an aperture 44 therein to accommodate the lobes 13,14; and the plate 43 is attached to rails 45 which extend to a clamp 46 which can be removably attached to the casing 47 of an electric drill.

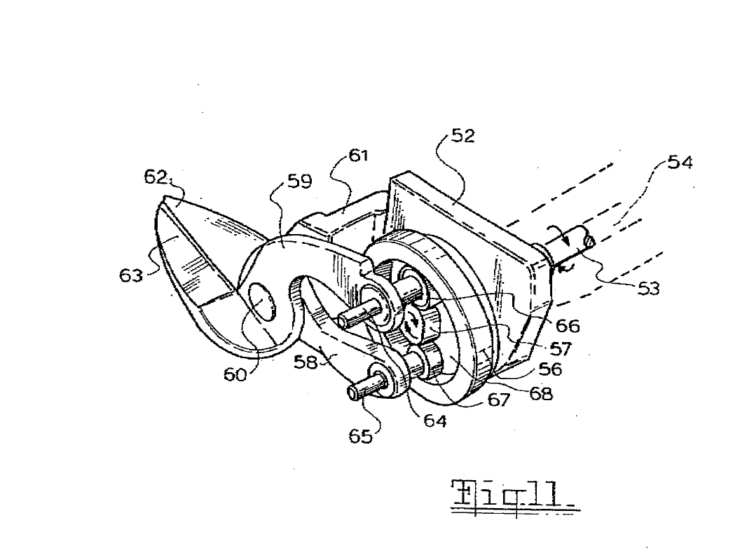

FIG. 10 depicts a fourth embodiment of the device with only a single pivoting blade. A lower blade 48 similar in configuration and operation to the corresponding blade of the first embodiment described above can pivot. However, the upper blade 49 is fixed against the side of the support housing 50. A cam 51, attached to the shaft of an electric drill, enables the blade 48 to reciprocate up and down.

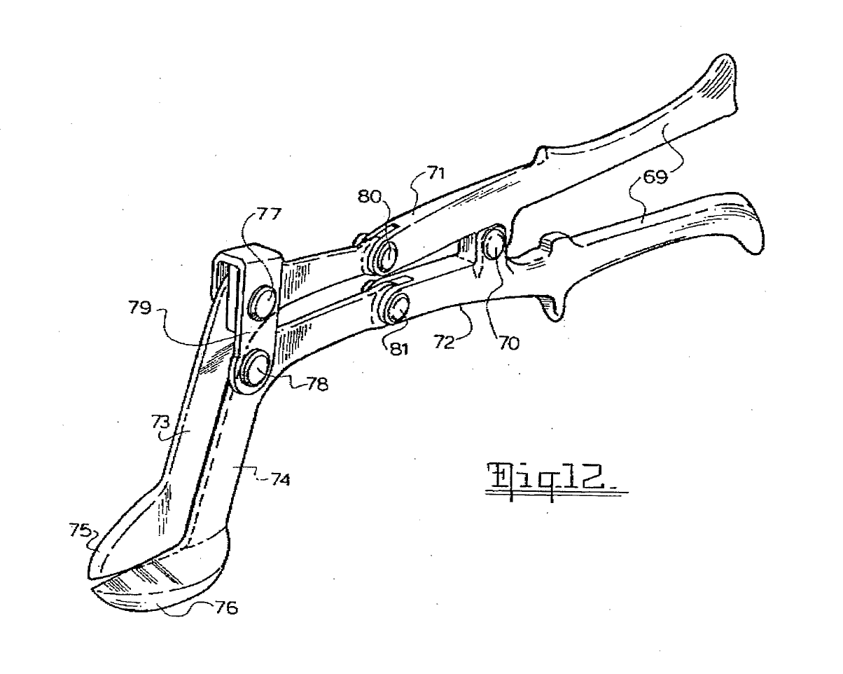

Referring now to FIG. 11, a fifth embodiment provides an alternative mechanism for a device with a single pivoting blade. A support plate 52 accommodates a rotatable shaft 53 extending therethrough. One end 54 of the shaft can be held in the chuck of an electric drill. The other end 55 of the shaft passes through a recessed circular plate 56 and terminates in an end portion 57 having a cam surface. The circular plate 56 is affixed to the shaft 53 to rotate simultaneously therewith. Upper 58 and lower 59 blade arms extending generally parallel to the support plate 52 are connected through a pivot pin 60 attached to an orthogonal extension 61 of the support plate 52. These blade arms end in blades 62, 63 similar to those described with reference above to all previous embodiments. The other ends of the blade arms are held on respective pivots 64, 65 which have attached to one end respective cam followers 66, 67. The end portion 57 of the shaft and the cam followers 66, 67 are held in operable alignment within the recess 68 of the circular plate 56. The recess 68 of the plate 56 is of an eccentric perimeter and the relative dimensions of the recess 68, cam surface and cam followers 66, 67 are such that rotation of the shaft 53 cause the lower blade 59 to reciprocate.

FIG. 12 depicts a fully manually operated embodiment of the present invention. A pair of scissor-like arms 69 with a central pivot 70, as is well known in the art, provide handles at one end for the user of the device and terminate at the other end in respective arms 71, 72. Blade arms 73, 74 having blades 75, 76 at one end are essentially similar to those described above with reference to all other embodiments, however, each pivot on an individual pivot 77, 78 on a common joining plate 79. The blade arms 73, 74 extend to be pivotally connected 80, 81 to the respective arms 71, 72′ of the handle. Conventional operation of the scissor-like arms will result in reciprocal motion of the blades 75, 76.

It will be appreciated that the material used for the manufacture of the various components of the present invention are selected to be of sufficient strength for the particular material to be cut.

It is to be understood that, if any prior art publication is referred to herein, such reference does not constitute an admission that the publication forms a part of the common general knowledge in the art, in Australia or in any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It will be appreciated that the above described embodiments are only exemplification of the various aspects of the present invention and that modifications and alterations can be made thereto without departing from the inventive concept as defined in the following claims.

1. A device for cutting ridged, corrugated or similar profile sheet material, said device comprising:
a support adapted to attach said device to a power source;
a cutting means adapted to cut said sheet material; said cutting means comprising (i) a first blade portion with a first blade and (ii) a second blade portion with a second blade;
a first coupling portion which operatively couples said first blade portion to said power source and adapted to allow pivoting of said first blade portion when said power source is activated; and
a second coupling portion which either (i) operatively couples said second blade portion to said power source and is adapted to allow pivoting of said second blade portion when said power source is activated or (ii) is adapted to prevent said second blade portion from pivoting when said power source is activated, as required;
wherein said pivoting of said first blade portion and/or said second blade portion provides a cutting action by said first blade and said second blade.

2. A device as defined in claim 1 wherein said sheet material is metal.

3. A device as defined in claim 2 wherein said metal is of a ridged or corrugated profile.

4. A device as defined in claim 1 wherein said cutting action includes scribing, shearing, cutting and the like.

5. A device as defined in claim 1 wherein said power source is selected from the group comprising mechanical, electrical and hydraulic means.

6. A device as defined in claim 5 wherein said power source is by electrical means in close association with said support.

7. A device as defined in claim 5 wherein said power source is by electrical means remote from said support.

8. A device as defined in claim 6 wherein said support is attached directly to an electric drill.

9. A device as defined in claim 8 wherein said support is attached directly to the shaft of said drill.

10. A device as defined in claim 8 wherein said support is attached to the chuck of said drill.

11. A device as defined in claim 7 wherein said power source is a portable battery pack.

12. A device as defined in claim 5 wherein said power source is mechanical means selected from a hand drill, auger, scissor-like handles or the like.

13. A device as defined in claim 1 wherein when said second blade portion is prevented from said pivoting, said first blade portion is adapted to move substantially upwardly when said device is in use sufficient for said first blade to meet said second blade to provide said cutting action.

14. A device as defined in claim 1 wherein said first and second coupling portions are adapted to enable a required grade of cut to be pre-determined from said cutting action.
